(19) United States
(12) Patent Application Publication
(10) Pub. No.: US 2016/0332456 A1
(43) Pub. Date: Nov. 17, 2016

(54) THERMAL PRINT HEAD

(71) Applicant: ROHM CO., LTD., Kyoto (JP)

(72) Inventor: Shojiro DAICHO, Kyoto (JP)

(21) Appl. No.: 15/152,184

(22) Filed: May 11, 2016

(30) Foreign Application Priority Data
May 15, 2015 (JP) 2015-099792

(51) Int. Cl. B41J 2/335

(52) U.S. Cl. CPC B41J 2/3353; B41J 2/3351

(57) ABSTRACT

The present invention is directed to a thermal, print head for preventing sticking phenomenon. The present invention provides a thermal print head A1, including: a substrate 1; an electrode layer 3; a resist layer 4 including a plurality of heat-generating portions 41 arranged in a main scanning direction, x; and a protection layer 55. The thermal print head A1 further includes a raised layer, being adjacent to the resist layer in a sub-scanning direction, and disposed between the substrate and the protection layer.

### BACKGROUND

The present invention is related to a thermal print head.

FIG. 15 shows an example of a conventional thermal print head. The thermal print head X shown in FIG. 1 includes a substrate 91, a glaze layer 92, an electrode layer 93, a resist layer 94 and a protection layer 95. The substrate 91 is a plate-shaped component including an insulating material. The glaze layer 92 is formed on a surface of the substrate 91 and comprises glass, for example. The glaze layer 92 has a heat storage 921. The heat storage 921 is band-shaped, extends along a main scanning direction, and has an arc-shaped cross-section, which is slightly protruding upward. The electrode layer 93 is formed on the glaze layer 92, and configured as a current path for selectively allowing current to flow to the resist layer 94. The electrode layer 93 has a common electrode 931 and a plurality of individual electrodes 932. The common electrode 931 and the individual electrodes 932 are electrically opposite electrodes. In the resist layer 94, a portion between a pan of she common electrode 931 and the individual electrode 932 along the main scanning direction becomes a heat-generating portion. The protection lover 95 is a component used for protecting the electrode layer 93, and comprises glass, for example.

The thermal print head X constitutes a main portion of a printer. The printer has multiple printing specifications, there are many kinds of thermal sensitive paper as printing medium, and a printing speed can be set as many speeds. According to such printing specification, there occurs a phenomenon called “sticking”, indicating that the thermal sensitive paper pressed to the resist layer 94 via the protection layer 95 slightly and repeatedly moves and stops. Such “sticking” phenomenon possibly reduces printing quality and improperly deteriorates the thermal print head X.

### BACKGROUND TECHNICAL LITERATURES

### Patent Literatures

[Patent literature 1] Japanese Unexamined Patent Application Publication No. 10-16268.

### BRIEF SUMMARY OF THE INVENTION

### Problems to be Solved

According to the above descriptions, the present invention provides a thermal print head for eliminating sticking.

### Solutions for Solving the Problems

The thermal print head of the present invention includes: a substrate; an electrode layer; a resist layer including a plurality of heat-generating portions arranged in a main scanning direction; and a protection layer. The thermal print head of the present invention further includes a raised layer, wherein the raised layers is adjacent to the resist layer in a sub-scanning direction, and disposed between the substrate and the protection layer.

In the preferred embodiment of the present invention, the electrode layer includes: a common electrode having a connecting portion extending along the main scanning direction and a plurality of common electrode bands extending from the connecting portion along the sub-scanning direction; and a plurality of individual electrodes respectively having a individual electrode band, wherein each individual electrode band respectively extends along the sub-scanning direction and disposed between adjacent common electrode bands in the main scanning direction.

In the preferred embodiment of the present invention, the resist layer intersects the plurality of common electrode bands and the plurality of individual electrode bands.

In the preferred embodiment of the present invention, the plurality of common electrode bands and the plurality of individual electrode bands are between the substrate and the resist layer.

In the preferred embodiment of the present invention, the raised layer comprises a downstream portion disposed at downstream side with respect to the resist layer in the sub-scanning direction.

The preferred embodiment of She present invention, the downstream pen ion of the raised saver and the resist layer are separated from each other.

In the preferred embodiment of the present invention, the downstream portion of the raised layer and the connecting portion of the common electrode are separated from each other.

In the preferred embodiment of the present invention, the raised layer comprises an upstream portion disposed at upstream side with respect to the resist layer in the sub-scanning direction.

In the preferred embodiment of the present invention, the upstream portion of the raised layer and the resist layer are separated from each other.

In the preferred embodiment of the present invention, a size of the downstream portion of the raised layer in the sub-scanning direction is smaller than a size of the upstream portion of the raised layer in the sub-scanning direction.

In the preferred embodiment of the present invention, the downstream portion of the raised layer in the sub-scanning direction is disposed between the resist layer and the connecting portion of the common electrode of the electrode layer.

In the preferred embodiment of the present invention, the resist layer is in a band shape extending long along the main scanning direction.

In the preferred embodiment of the present invention, the resist layer is formed by baking resistor paste, which is thick film printed.

In the preferred embodiment of the present invention, the thermal print head includes a glaze layer, which is formed on the substrate and disposed between the substrate, and the resist layer/the electrode layer.

In the preferred embodiment of the present invention, the glaze layer comprises glass.

In the preferred embodiment of the present invention, the raised layer is formed by using a glass paste having a viscosity tower than that of a glass paste used as material of the glaze layer.

In the preferred embodiment of the present invention, the substrate is blanket covered by the glaze layer.

In the preferred embodiment of the present invention, the glaze layer comprises a taper portion having a thickness which becomes smaller toward a downstream end of the substrate in the sub-scanning direction.

In the preferred embodiment of the present invention, at least one part of the connecting portion of the common electrode is formed at the taper portion of the glaze layer.

In the preferred embodiment of the present invention, the connecting portion of the common electrode is wholly formed at the taper portion of the glaze layer.

In the preferred embodiment of the present invention, at least one part of the connecting portion of the common electrode has a thickness larger than that of the common electrode band of the common electrode.

In the preferred embodiment of the present invention, the glaze layer comprises a heat storage, and the heat storage is in a band shape extending along the sub-scanning direction and disposed between the resist layer and the substrate.

In the preferred embodiment of the present invention, the heat storage has a circular arc-shaped section.

In the preferred embodiment of the present invention, the glaze layer comprises an auxiliary portion, and the auxiliary portion covers an area disposed at upstream side with respect to the heat storage in the sub-scanning direction in the substrate.

In the preferred embodiment of the present invention, the auxiliary portion is formed by using a glass paste having a viscosity lower than that of a glass paste used as material of the heat storage.

In the preferred embodiment of the present invention, the raised layer has the same material as the auxiliary portion of the glaze layer.

In the preferred embodiment of the present invention, the substrate comprises ceramics.

In the preferred embodiment of the present invention, the substrate comprises Al₂O₃.

In the preferred embodiment of the present invention, a thickness of the raised layer is 90%˜100% of a thickness of the resist layer.

In the preferred embodiment of the present invention, a thickness of the raised layer is 100%˜110% of a thickness of the resist layer.

### Effects of the Present Invention

According to the present invention, the raised layer adjacent to the resist layer in the sub-scanning direction and disposed between the substrate and the protection layer is provided. Thus, the protection laser becomes a relatively flat shape for covering the adjacent resist layer and raised layer. Hence, only the portion covering the resist layer in the protection layer can be prevented from protruding. More flat shape the protection layer is, more smoothly the thermal sensitive paper as printing medium is delivered along the sub-scanning direction by the thermal print head in printing. Therefore, the sticking phenomenon can be prevented.

Other features and advantages of the present invention are more concrete by referring the accompanying figures and the following detailed descriptions.

### BRIEF DESCRIPTION OF THE DRAWINGS

FIG. 1 is a top view of a thermal print head in accordance with the first embodiment of the present invention.

FIG. 2 is a cross-sectional view along the line II-II of FIG. 1.

FIG. 3 is an enlarged top view showing a main portion of the thermal print head of FIG. 1.

FIG. 4 is an enlarged cross-sectional view showing the main portion along the line VI-VI of FIG. 3.

FIG. 5 is an enlarged cross-sectional view showing the main portion of the thermal print head of FIG. 1.

FIG. 6 is an enlarged cross-sectional view showing a main portion in an example of a method for fabricating the thermal print head in FIG. 1.

FIG. 7 is an enlarged cross-sectional view showing a main portion in an example of a method for fabricating the thermal print head in FIG. 1.

FIG. 8 is an enlarged cross-sectional view showing a main portion in an example of a method for fabricating the thermal print head in FIG. 1.

FIG. 9 is an enlarged cross-sectional view showing a main portion in an example of a method for fabricating the thermal print head in FIG. 1.

FIG. 10 is an enlarged cross-sectional view showing a main portion in an example of a method for fabricating the thermal print head in FIG. 1.

FIG. 11 is an enlarged cross-sectional view showing a main portion in an example of a method for fabricating the thermal print head in FIG. 1.

FIG. 12 is an enlarged view showing a main portion of a thermal print head in accordance of the second embodiment of the present invention.

FIG. 13 is an enlarged view showing a main portion of a thermal print head in accordance of the third embodiment of the present invention.

FIG. 14 is an enlarged view showing a main portion of a thermal print head in accordance of the fourth embodiment of the present invention.

FIG. 15 is an enlarged cross-sectional view showing a main portion of an example of a conventional thermal print head in the prior art.

### DETAILED DESCRIPTION

Hereinafter, the preferred embodiment of the present invention is referred to the drawings and specifically described.

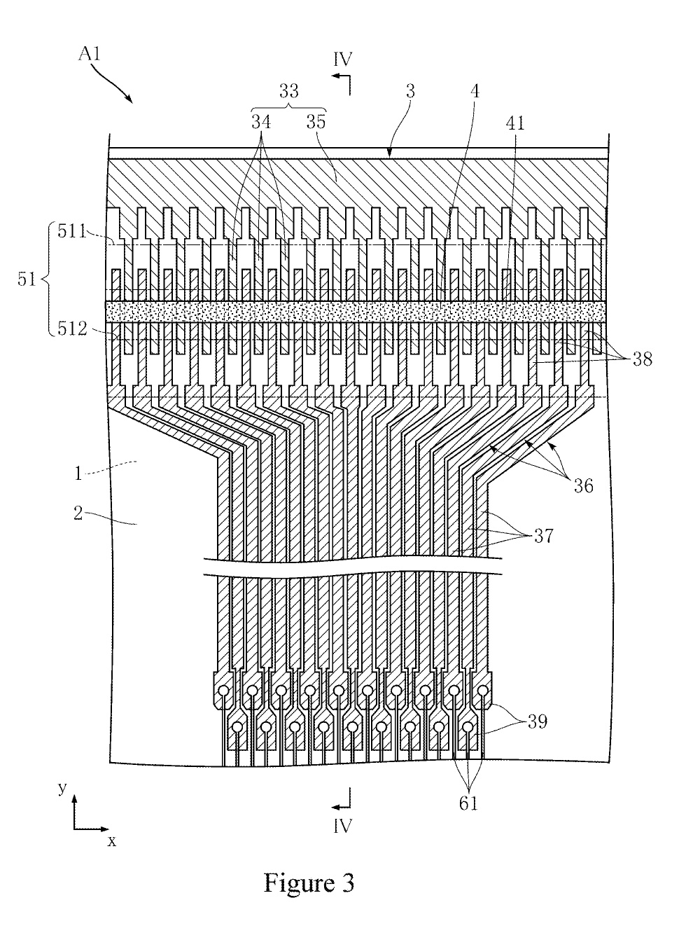

FIGS. 1 to 5 show an example of a thermal print head in the present invention. In this embodiment, a thermal print head A1 includes a substrate 1, a glaze layer 2, an electrode layer 3, a resist layer 4, a raised layer 51, a protection layer 55, a driving IC (integrated circuit) 71, a sealing resin 72, a connector 73, a wiring substrate 74 and a heat-dissipating component 75. The thermal print head A1 is, for example, assembled as a component of a printer to perform printing to the thermal sensitive paper for forming a barcode sheet or a receipt. In addition, for better understanding, the protection layer 55 is omitted in FIGS. 1 and 3. In these figures, a main scanning direction is set as an x direction, a sub-scanning direction is set as a y direction, and a thickness direction of the substrate 1 is set as a z direction.

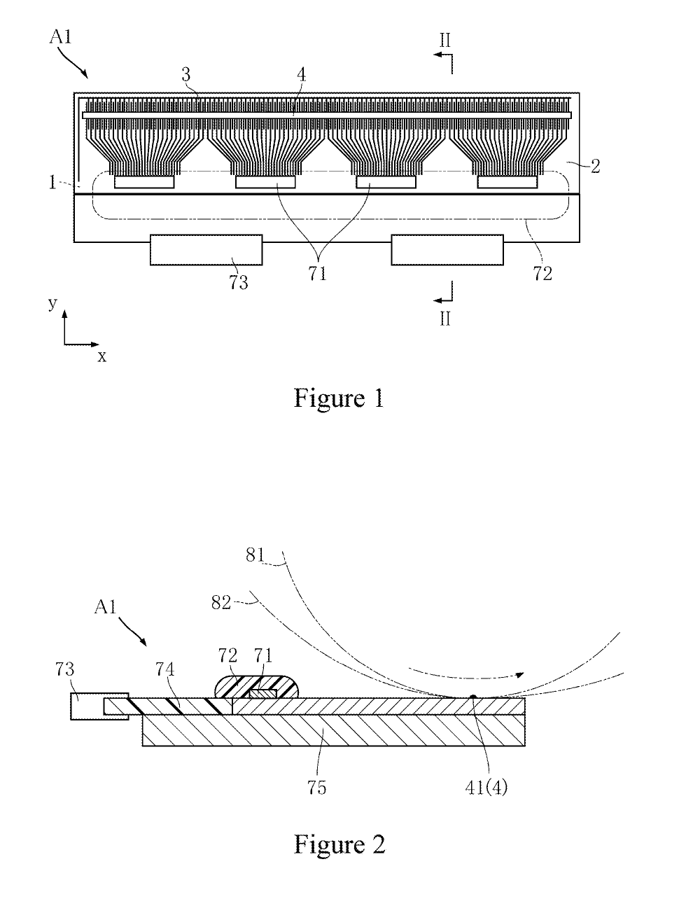

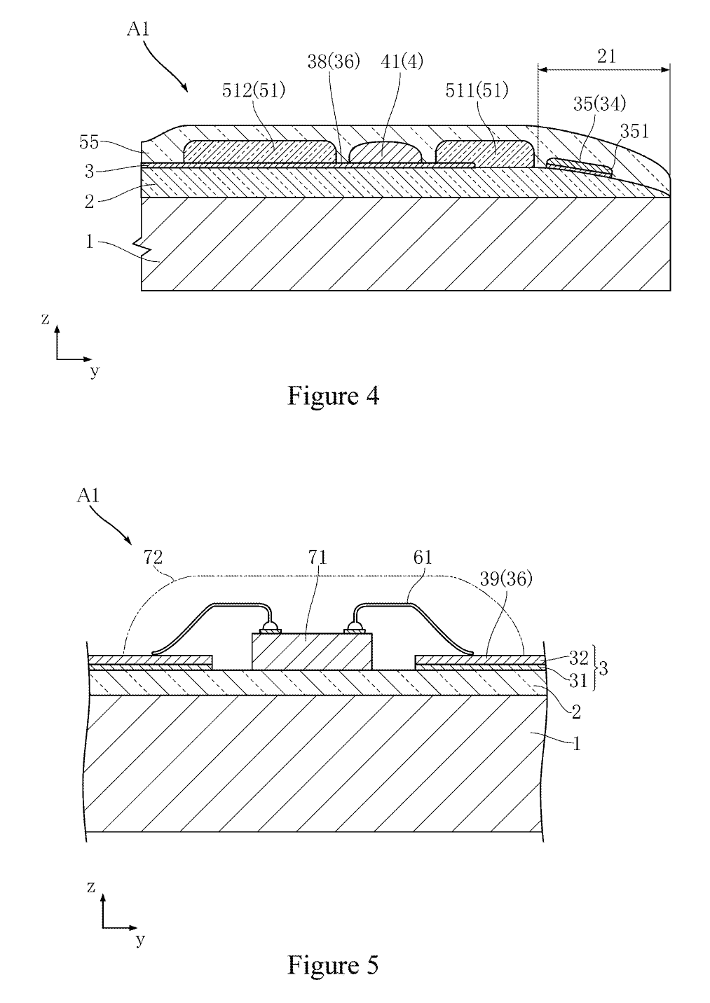

FIG. 1 is a top view of the thermal print head A1. FIG. 2 is a cross-sectional view along the line II-II in FIG. 1. FIG. 3 is an enlarged top view showing a main portion of the thermal print head A1. FIG. 4 is an enlarged cross-sectional view showing the main portion along the line VI-VI of FIG. 3. FIG. 5 is an enlarged cross-sectional view showing the main portion of the thermal print head A1.

The substrate 1, for example, includes ceramics such as Al₂O₃, and has a thickness of about 0.6-1.0 mm, for example. As shown in FIG. 1, the substrate 1 is a long rectangular shape extending long along the main scanning direction. In addition to the substrate 1, a structure may comprise a wiring substrate 74 laminating a substrate layer including glass epoxy resin and a wiring layer including Cu, for example. On a lower surface of the substrate 1, a heat-dissipating component 75 including, for example, metals such as Al is disposed. In the configuration having the wiring-substrate 74, the substrate 1 and the wiring substrate 74 are adjacently disposed on the heat-dissipating component 75, for example, and the electrode layer 3 on the substrate 1 and the wiring (of an IC connected to the wiring) of the wiring substrate 74 are connected through wire bonding, for example. Further, a connector 73 shown in FIG. 1 can also be disposed on the wiring substrate 74.

The glaze layer 2 is formed on the substrate 1, and includes glass material such as amorphous glass, for example. The softening point of the glass material is 800˜850° C. for example. the thick film printing is performed on glass paste and then the glass paste is baked to form the glaze layer 2. In this embodiment, the glaze layer 2 has a taper portion 21. The taper portion 21 covers a part in the vicinity of a downstream end of the substrate 1 in the sub-scanning direction y. The taper portion 23 has a thickness which becomes smaller towards the downstream end of the substrate 1 in the sub-scanning direction y. Additionally, in this embodiment, the upper surface of the substrate 1 shown in the figure is blanket covered by the glaze layer 2.

The electrode layer 3 is configured for forming a path applying the electric power to the resist layer 4, and includes a conductor constituted mainly by Ag. The electrode layer 3 is not particularly limited only if being made of conductive material. As an example of the electrode layer 3, as shown in FIG. 5, the configuration includes a first layer 31 and a second layer 32.

The first layer 31 is formed on the glaze layer 2 by performing printing and baking on paste including an organic Ag compound, for example. The first layer 31 includes the organic Ag compound as Ag of the main constituent. In addition, for example, the first layer 31 includes Pd in a content of more than 0.1 wt % and no more than 30 wt %. Additionally, the first layer 31 does not include glass. The first layer 31 has a thickness of 0.3˜1.0 μm, for example.

The second layer 32 is disposed on the first layer 31, and formed by, for example, performing printing and baking on Ag paste, which is used for thick film printing. The second layer 32 includes Ag powder as Ag of the main constituent. The Ag powder is spherical or flake-shaped, and has an average particle size of 0.1˜10 μm, for example. Further, the second layer 32 includes, tor example, glass in a content of 0.5˜10 wt %. The glass is borosilicate glass or lead borosilicate glass, for example. Further, the second layer 32 includes, for example, Pd in a content of more than 0.1 wt % and less than 30 wt %, which is less than the content of Pd in the first layer 31. The second layer 32 has a thickness of 2˜10 μm, for example. The surface of the second layer 32 becomes relatively rough due to the distribution of the Ag powder.

As shown in FIG. 3, the electrode layer 3 has a common electrode 33 and a plurality of individual electrodes.

The common electrode 33 has a plurality of common electrode bands 34 and a connecting portion 35. The connecting portion 35 is disposed near the downstream end of the substrate 1 in the direction of sub-scanning direction y, and is in a band shape extending along the main-scanning direction x. The plurality of common electrode bands 34 respectively extend from the connecting portion 35 along the sub-scanning direction y, and are arranged at equal pitches in the main-scanning direction x. In this embodiment, at least a part of the connecting portion 35 is formed at the taper portion 21 of the glaze layer 2. Further, in this embodiment, the connecting portion 35 is wholly formed at the taper portion 21. In addition, in this embodiment, an Ag layer 351 is laminated on the connecting portion 35. The Ag layer 351 is a component used for decreasing resistance of the connecting portion 35. By forming the Ag layer 351, the connecting portion becomes a configuration thicker than the common electrode band 34 or the individual electrode 36.

The plurality of individual electrodes 36 are components for partially applying the electric power to the resist layer 4, and have opposite polarity relatively to the common electrode 33. The individual electrodes 36 extend from the resist layer 4 toward the driving IC 71. The plurality of individual electrodes 36 are arranged in the main-scanning direction X, and respectively include a individual electrode band 38, a connecting portion 37 and a bonding portion 39.

Each individual electrode band 38 is a band portion extending along the sub-scanning direction y, and disposed between two adjacent common electrode bands 34 of the common electrode 33. The width of the individual electrode band 38 of the individual electrode 36 and the width of the common electrode band 34 of the common electrode 33 is set as less than 25 μm, for example. The interval between the adjacent individual electrode band 38 of the individual electrode 36 and the common electrode band 34 of the common electrode 33 is set as less than 40 μm, for example.

The connecting portion 37 is the portion extending from the individual electrode band 38 toward the driving IC 71, and has a part mostly along the sub-scanning direction y and a part inclined relative to the sub-scanning direction y. The width of the most part of the connecting portion 37 is set as less than 20 μm, for example, and the interval between the adjacent connecting portions 37 is set as less than 20 μm.

The bonding portion 39 is formed at an end portion of the individual electrode 36 in the sub-scanning direction y for bonding wirings 61, which is used for connecting the individual electrode 36 and the driving IC 71. The bonding portions 39 of the adjacent individual electrodes arc alternately arranged with each other along the sub-scanning direction y. Therefore, even though the width of the bonding portion 39 is larger than that of the most part of the connecting portion 37, mutual interference can be avoided.

The portion between the adjacent bonding portions 39 in the connecting portion 37 has the smallest width in the individual electrode 36, and the width is less than 10 μm, for example. Further, the interval between the connecting portion 37 and the adjacent bonding portion 39 is also less than 10 μm, for example. Thus, the common electrode 33 and the plurality of individual electrodes 36 become line patterns with small line width and wiring intervals.

The resist layer 4 includes the material, such as ruthenium oxide, having resistance larger than the material constituting the electrode layer 3, and is formed in a band shape along the main-scanning direction x. The resist layer 4 intersects the plurality of common electrode band 34 of the common electrode 33 and the individual electrode band 38 of the plurality of the individual electrodes 36. Further, the resist layer 4 is laminated on an opposite side of the substrate 1 relatively to the plurality of common electrode bands 34 of the common electrode 33 and the individual electrode bands 38 of the plurality of individual electrodes 36. In the resist layer 4, the portion between each common electrode band 34 and each individual electrode band 38 becomes a heat-generating portion 41 for generating heat, by using the electrode layer 3 to partially apply the electric power. Print dots are formed by the heat generation of the heat-generating portion 41. The resist layer 4 has a thickness of 4 μm˜6 μm, for example.

A raised layer 51 constitutes a layer having a portion raising from the glaze layer toward a side, to which an upper surface of the substrate 1 in the figure faces, and is disposed between the substrate 1 and the protection layer 53. In this embodiment, the raised layer 51 includes a downstream portion 511 and an upstream portion 512. The material of the raised layer 51 is not particularly limited, and can be formed of glass paste material having a viscosity lower than that of the glass paste material tor forming the glaze layer 2. In the situation that the thickness of the resist layer 4 is set as 100%, the thickness of the raised layer 51 is preferably 90%˜110%.

The downstream portion 511 is disposed at the downstream side with respect to the resist layer 4 in the sub-scanning direction y. The downstream portion 511 is in a band shape extending long along the main-scanning direction x. The downstream portion 511 and the resist layer 4 are separated from each other. The downstream portion 511 and the connecting portion 35 of the common electrode 33 are separated from each other. The size of the downstream portion 511 in the sub-scanning direction y is about 500 μm, for example.

An upstream portion 512 is disposed at the upstream side with respect to the resist layer 4 in the sub-scanning direction. The upstream portion 512 is in a band shape extending long along the main-scanning direction x. The upstream portion 512 and the resist layer 4 are separated from each other. In this embodiment, the size of the upstream portion 512 in the sub-scanning direction y is larger than the size of the downstream portion 511 in the sub-scanning direction y, and is about 800 μm˜2 mm, for example.

The protection layer 55 is used for protecting the electrode layer 3 and the resist layer 4. The protection layer 55 includes amorphous glass, for example. However, the protection layer 55 makes the area, which includes the bonding portion 39 of the plurality of individual electrodes 36, to be exposed.

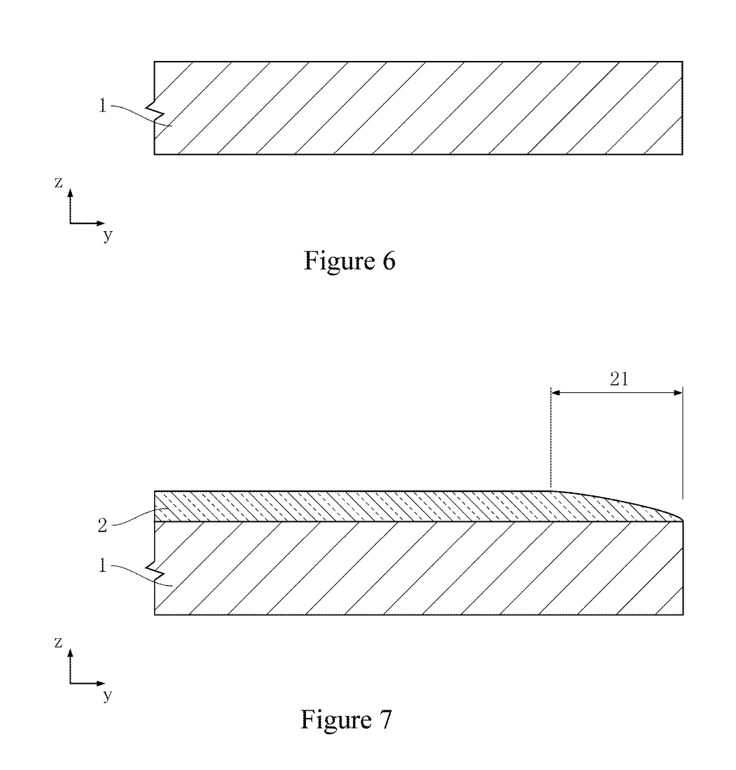

The driving IC 71 functions to allow the resist layer 4 generates heat partially by selectively conducting the plurality of individual electrodes 36. A plurality of pads are disposed at the driving IC 71. FIG. 5 is an enlarged cross-sectional view showing a main portion in the yz plane crossing the driving IC 71. As shown in FIG. 3 and FIG. 6, the pads of the driving IC 71 are connected to the plurality of individual electrodes 36 via multiple wirings 61, which are bonded thereon respectively. The wiring 61 includes Au. As shown in FIG. 1 and FIG. 6, the driving IC 71 is covered by the sealing resin 72. The sealing resin 72 includes black soft resin, for example. Further, the driving IC 71 and the connector 73 are connected by a signal line, which is not shown in figures.

Then, with regard to an example of a method for fabricating a thermal print head A1, referring to FIG. 6 to FIG. 10, the descriptions are provides as follows.

First, as shown in FIG. 6, a substrate 1 including Al₂O₃ is prepared, for example. Then, after glass paste is thick film printed on the substrate 1, baking is performed on the glass paste, and thus a glaze layer 2 is formed as shown in FIG. 7. At this time, at a downstream end portion of the substrate 1 in the sub-scanning direction y, the coating amount of the glass paste is relatively reduced. Thus, a taper portion 21 is formed on the glaze layer 2.

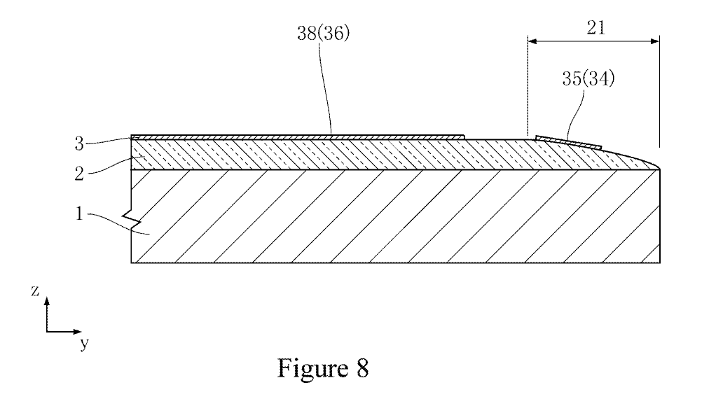

Subsequently, as shown in FIG. 8, an electrode layer 3 is formed. The method for forming the electrode layer is not particularly limited, for example, the situation that the electrode layer 3 includes the above-mentioned first layer 31 and second layer 32 is illustrated. First, a first material layer is formed. The first material layer is formed by performing thick film printing the paste including an organic Ag compound. The paste including an organic Ag compound includes an organic Ag compound, Pd, and resin. The content of the resin is 60˜80 wt %, for example.

Then, a second material layer is formed. The second material layer is formed by performing thick film printing the Ag paste, which is used for thick film printing. The Ag paste for thick film printing includes Ag particles, glass frit, Pd, and resin. The content of the resin is 20˜30 wt %, for example. An Ag paste layer is constituted by the first material layer and the second material layer. Subsequently, the Ag paste layer is baked to form a conductor layer having Ag as a main constituent. Then, patterning is implemented on the conductor layer by using, for example, etching, to form an electrode layer 3, which is constituted by lamination of a first layer 31 and a second layer 32.

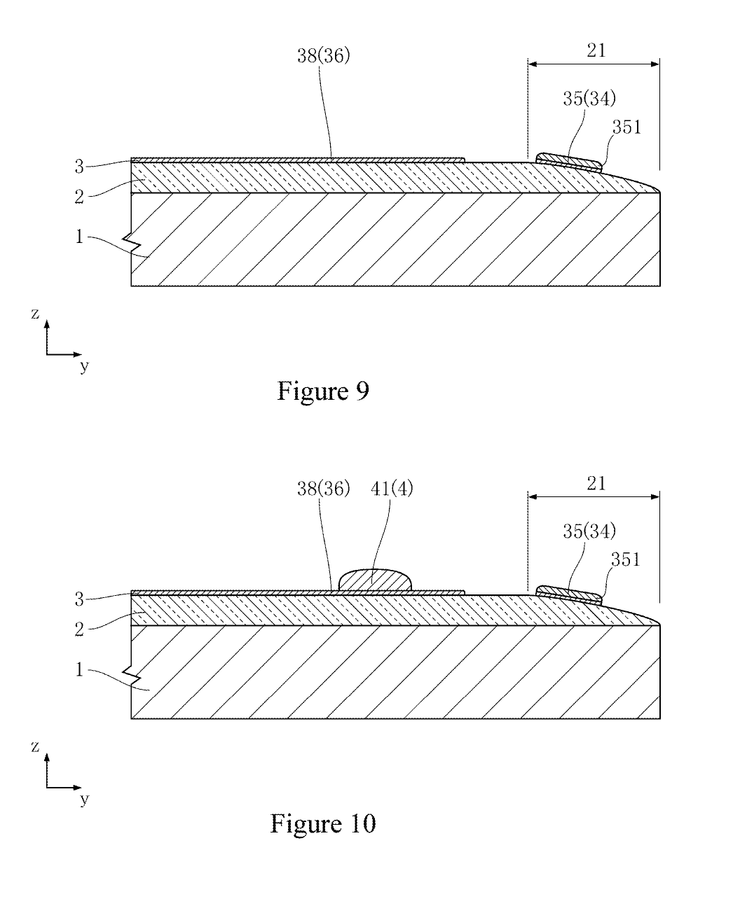

Subsequently, as shown in FIG. 9, an Ag layer 351 is formed. The Ag layer 351 is formed by coating Ag paste on the connecting portion 35 and baking the Ag paste, for example.

Subsequently, as shown in FIG. 10, a resist layer 4 is formed. The resist layer 4 is formed by the following way, for example. The resistor paste including resistor such as ruthenium oxide is thick film printed, and baking is performed on the resistor paste.

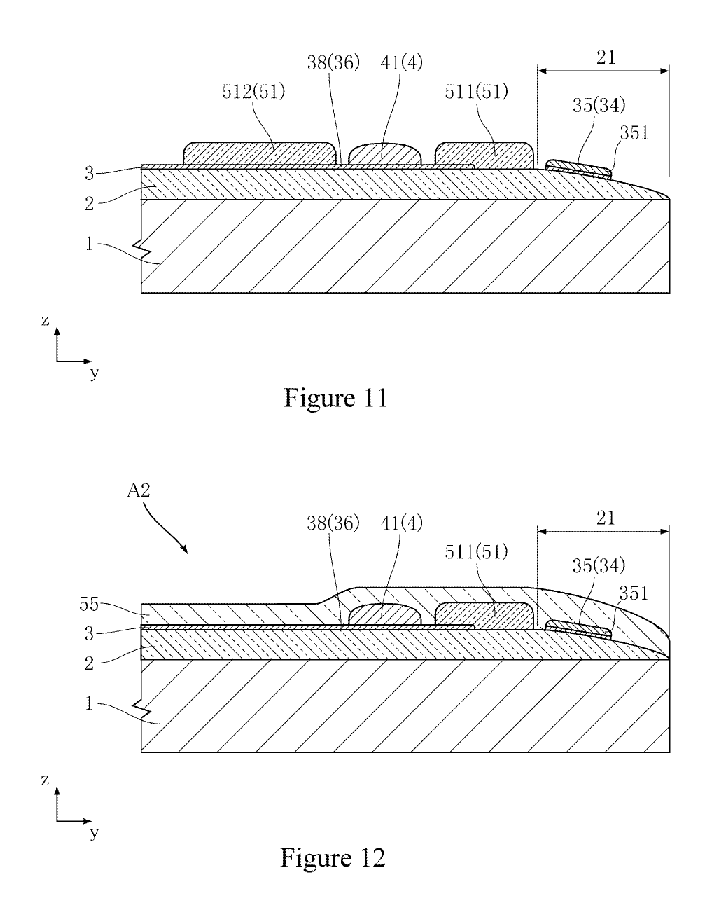

Subsequently, as shown in FIG. 11, a raised layer 51 is formed. The sequence for forming the raised layer 51 and the resist layer 4 can be in a reversed order. The raised layer 51 is formed by, for example, performing thick film printing to coat glass paste in a band shape on an area between the connecting portion 35 of the common electrode 33 and the resist layer 4 and an area closer to the upstream side in the sub-scanning direction y than the resist layer 4. Then, the resistor paste is baked, and thus a raised layer 51 having a downstream portion 511 and an upstream portion 512 is obtained.

Subsequently as shown in FIG. 12, a protection layer 55 is formed. The protection layer 55 is formed by the following way, for example. The glass paste is coated on an area for forming the protection layer 55 by thick film printing, and the glass paste is baked. Then, a driving IC 71 is mounted, wirings 61 are bonded, and the substrate 1 and a wiring substrate 74 are assembled to a heat-dissipating component 75, such that a thermal print head A1 is obtained.

Then, the effects of the thermal print head A1 are illustrated.

According to this embodiment, the raised layer 51 is included, and the raised layer 51 is adjacent to the resist layer 4 in the sub-scanning direction y, and disposed between the substrate 1 and the protection layer 55. Thus, as shown in FIG. 4, the protection layer 55 becomes a relatively flat shape covering the adjacent resist layer 4 and raised layer 51. Hence, only the portion covering the resist layer 4 in the protection layer 55 can be prevented from protruding. More flat shape the protection layer is, more smoothly the thermal sensitive paper as printing medium is delivered along the sub-scanning direction y by the thermal print head A1 in printing. Therefore, the sticking, phenomenon can be prevented.

The thickness of the raised layer 51 is 90%˜110% of the thickness of the resist layer 4, so as to properly achieve the effect of preventing the sticking phenomenon. In addition, in the situation that the thickness of the raised layer 51 is 90%˜100% of the thickness of the resist layer 4, the heat-generating portion 41 of the resist layer 4 can be precisely pressed to the printing medium, which is preferable in terms of improving quality of printing. However, in the situation that the thickness of the raised layer 51 is 100%˜110% of the thickness of the resist layer 4, the effect, of preventing the sticking phenomenon is further enhanced.

The raised layer 51 includes the downstream portion 511. The downstream portion 511 is disposed at the downstream side with respect to the resist layer 4 in the sub-scanning direction y. According to the inventors' opinions, in the situation that the protection layer 55 is partially raised due to the resist layer 4 and the protection layer 55 disposed at the downstream side of the resist layer 4 in the sub-scanning direction y is relatively recessed, the sticking phenomenon easily occurs. Since the downstream portion 551 is included, the protection layer 55 in the downstream side of the resist layer 4 in the sub-scanning direction y is prevented from being apparently recessed, which is preferable in terms of preventing the sticking phenomenon.

The downstream portion 511 is disposed between the resist layer 4 and the connecting portion 35 of the common electrode 33. Both the resist layer 4 and the connecting portion 35 are in a band shape extending along a main scanning direction x, and the protection layer 55 between the resist layer 4 and the connecting portion 35 is easily grooved recessed. Since a downstream portion 511 is included, the protection layer 55 is prevented from being grooved recessed, so as to properly prevent the sticking phenomenon.

The raised layer 51 includes the upstream portion 512. The upstream portion 512 is disposed at an upstream side with respect to the resist layer 4 in the sub-scanning direction y. Thus, not only the protection layer 55 disposed at the downstream side with respect to the resist layer 4 in the sub-scanning direction y is prevented from being apparently recessed, but also the protection layer 55 disposed at the upstream side in the sub-scanning direction y is prevented from being apparently recessed. Thus, the effect of preventing the sticking phenomenon can be further enhanced.

A taper portion 21 is formed at the glaze layer 2. The connecting portion 35 of the common electrode 33 is arranged on the taper portion 21. Thus, the connecting portion 35 can be prevented from significantly protruding relatively to the common electrode band 34 or the individual electrode 36. Particularly, in order to reduce the resistance, it is effective to dispose the connecting portion 35 at the taper portion 21 in a configuration which the Ag layer 351 is formed at the connecting portion 35, for example, and the connecting portion 35 is thick-finished.

FIG. 12 to FIG. 14 show another embodiment of the present invention. In addition, in these figures, components like those in the previous embodiments are denoted by the same reference numerals.

FIG. 12 shows a thermal prim head according to the second embodiment of the present invention. The raised laser 51 of the thermal print head A2 in this embodiment has difference constituents from the thermal print head A1.

In the thermal print head A2, the raised layer 51 includes only a downstream portion 511, and does not include an upstream portion 512. The downstream portion 511 has the same constitutions as the downstream portion 511 of the thermal print head A1.

According to this embodiment, the sticking phenomenon can also be prevented. Even though the upstream portion 512 is omitted, since the downstream portion 511, which is considered to be effective for preventing the sticking phenomenon, is included, the effect of preventing the sticking phenomenon is correspondingly achieved.

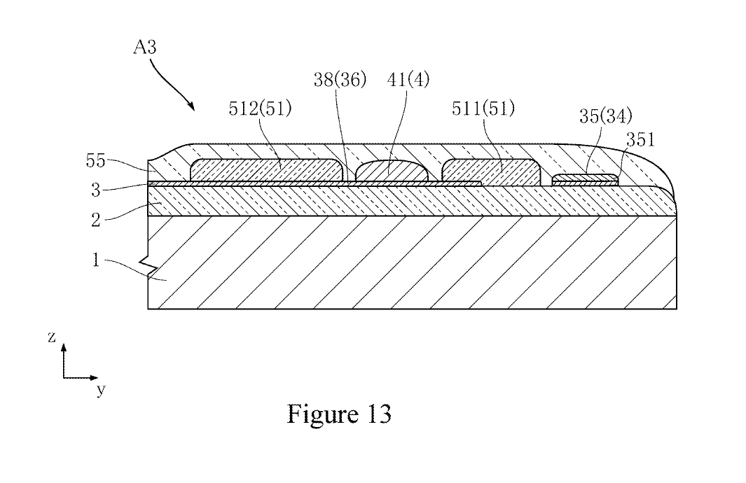

FIG. 13 shows a thermal print head according to the third embodiment of the present invention. The thermal print head A3 of this embodiment has different constitutions of a glaze layer 2 from those of the thermal print head A1 and the thermal print head A2.

In the thermal print head A3, the glaze layer 2 has a substantially constant thickness on the entire surface on the substrate 1, and has no taper portion 21. In the thermal print head A3 shown in the figure, the raised layer 51 includes a downstream portion 511 and m upstream portion 512, but also can be a raised layer 51 including only an upstream portion 512, for example.

According to tins embodiment, the sticking phenomenon can also be prevented. Although the glaze layer 2 does not include a taper portion 21, since a raised layer 51, especially a downstream portion 511, is included, the area of the protection layer 55 disposed at the downstream side with respect to the resist layer 4 in the sub-scanning direction y can be prevented from being partially and apparently recessed.

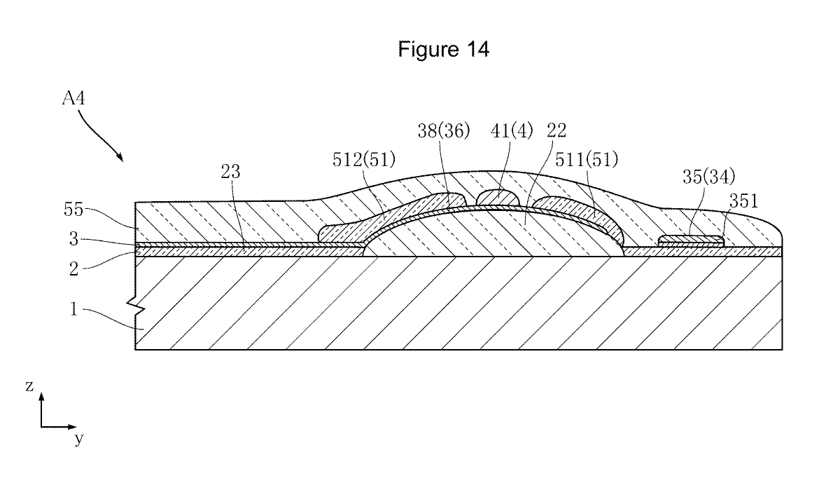

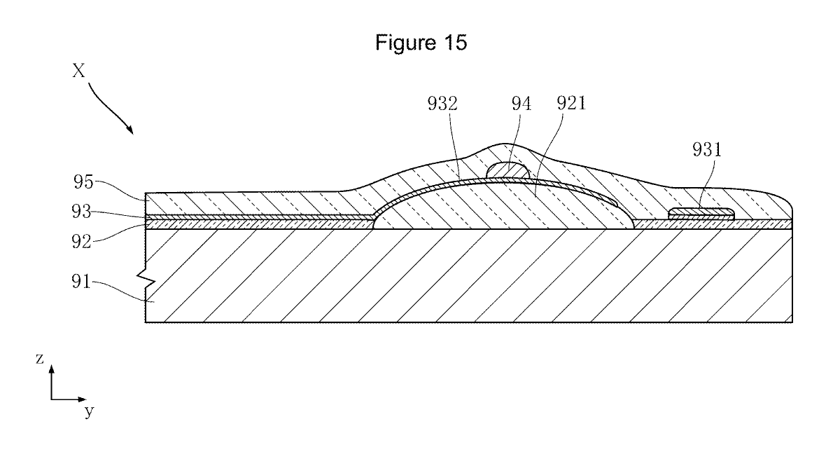

FIG. 14 shows a thermal print head according to the fourth embodiment of the present invention. The glaze layer 2 of the thermal print head A4 in this embodiment has different constitutions from the above embodiments.

In the thermal print head A4, the glaze layer 2 includes a heat storage 22 and an auxiliary portion 23.

The heal storage 22 is in a band shape extending along the main scanning direction x, and has a circular arc-shaped section slightly protruding upward in the figure. The resist layer 4 is formed on the heat storage 22. The heat storage 22 is used as the component for preventing heat generated from the heat-generating portion 41 of the resist layer 4 from being excessively delivered to the substrate 1.

The auxiliary portion 23 is formed so as to cover the portion exposed from the heat storage 22 in the substrate 1. The heat storage 22 is configured to be the component suitable for forming a smooth surface of the electrode layer 3 by covering the surface, which is a relatively rough surface, of the substrate 1.

The heat storage 22 and the auxiliary portion 23 include glass, for example. The specific selection of glass is completed in view of full usage of the heat storage function of the heat storage 22 and the smooth function of the auxiliary portion 23. In addition, as the material of the auxiliary portion 23, preferably, the glass paste having a viscosity lower than that of the glass paste being the material of the heat storage 22 is used.

Further, in this embodiment, the downstream portion 511 and the upstream portion 512 of the raised layer 51 include the same material as the auxiliary portion 23 of the glaze layer 2.

According to this embodiment, the sticking phenomenon can also be prevented.

The thermal print head of the present invention is not limited to those in the above embodiments. Various designs and changes can be freely implemented to each part of the thermal print head of the present invention.

1. A thermal print head, comprising;
a substrate;
an electrode layer;
a resist layer, including a plurality of heat-generating portions arranged in a main scanning direction;
a protection layer; and
a raised layer, being adjacent to the resist layer in a sub-scanning direction, and disposed between the substrate and the protection layer.

2. The thermal print head according to claim 1, wherein the electrode layer comprises:
a common electrode having a connecting portion extending along the main scanning direction and a plurality of common electrode bands extending from the connecting portion along the sub-scanning direction; and
a plurality of individual electrodes respectively having a individual electrode band, wherein each individual electrode band respectively extends along the sub-scanning direction and disposed between adjacent common electrode bands in the main scanning direction.

3. The thermal print bead according to claim 2, wherein the resist layer intersects the plurality of common electrode bands and the plurality of individual electrode bands.

4. The thermal print head according to claim 3, wherein the plurality of common electrode bands and the plurality of individual electrode bands are between the substrate and the resist layer.

5. The thermal print head according to claim 2, wherein the raised layer comprises a downstream portion disposed at downstream side with respect to the resist layer in the sub-scanning direction.

6. The thermal print head according to claim 5, wherein the downstream portion of the raised layer and the resist layer are separated from each other.

7. The thermal print head according to claim 6, wherein the downstream portion of the raised layer and the connecting portion of the common electrode are separated from each other.

8. The thermal print head according to claim 5, wherein the raised layer comprises an upstream portion disposed at upstream side with respect to the resist layer in the sub-scanning direction.

9. The thermal print head according to claim 8, wherein the upstream portion of the raised layer and the resist layer are separated from each other.

10. The thermal print head according to claim 8, wherein a size of the downstream portion of the raised layer in the sub-scanning direction is smaller than a size of the upstream portion of the raised layer in the sub-scanning direction.

11. The thermal print head according to claim 5, wherein the downstream portion of the raised layer in the sub-scanning direction is disposed between the resist layer and the connecting portion of the common electrode of the electrode layer.

12. The thermal print head according to claim 2, wherein the resist layer is in a band shape extending long along the main scanning direction.

13. The thermal print head according to claim 12, wherein the resist layer is formed by baking resistor paste, which is thick film printed.

14. The thermal print head according to claim 2, comprising a glaze layer, wherein the glaze layer is formed on the substrate and disposed between the substrate, and the resist layer/the electrode layer.

15. The thermal print head according to claim 14, wherein the glaze layer comprises glass.

16. The thermal print head according to claim 15, wherein the raised layer is formed by using a glass paste having a viscosity lower than that of a glass paste used as material of the glaze layer.

17. The thermal print head according to claim 15, wherein the substrate is blanket covered by the glaze layer.

18. The thermal print head according to claim 17, wherein the glaze layer comprises a taper portion having a thickness which becomes smaller toward a downstream end of the substrate in the sub-scanning direction.

19. The thermal print head according to claim 18, wherein at least one part of the connecting portion of the common electrode is formed at the taper portion of the glaze layer.

20. The thermal print head according to claim 19, wherein the connecting portion of the common electrode is wholly formed at the taper portion of the glaze layer.

21. The thermal print head according to claim 14 wherein at least one part of the connecting portion of the common electrode has a thickness larger than that of the common electrode band of the common electrode.

22. The thermal print head according to claim 2, wherein the glaze layer comprises a heat storage, and the heat storage is in a band shape extending along the sub-scanning direction and disposed between the resist layer and the substrate.

23. The thermal print head according to claim 22, wherein the heat storage has a circular arc-shaped section.

24. The thermal print head according to claim 23, wherein the glaze layer comprises an auxiliary portion, and the auxiliary portion covers an area disposed at upstream side with respect to the heat storage in the sub-scanning direction in the substrate.

25. The thermal print head according to claim 24, wherein the auxiliary portion is formed by using a glass paste having a viscosity lower than that of a glass paste used as material of the heat storage.

26. The thermal print head according to claim 24, wherein the raised layer has the same material as the auxiliary portion of the glaze layer.

27. The thermal print head according to claim 1, wherein the substrate comprises ceramics.

28. The thermal print head according to claim 27, wherein, the substrate comprises Al₂O₃.

29. The thermal print head according to claim 1, wherein a thickness of the raised layer is 90%˜100% of a thickness of the resist layer.

30. The thermal print head according to claim 1, wherein a thickness of the raised layer is 100%˜110% of a thickness of the resist layer.
